(19) United States
(12) Patent Application Publication
(10) Pub. No.: US 2025/0252212 A1
(43) Pub. Date: Aug. 7, 2025

(54) DEVICE AND METHOD FOR PROCESSING IMAGE

(71) Applicant: GRABTAXI HOLDINGS PTE. LTD., Singapore (SG)

(72) Inventors: Philipp Wolfgang Josef KANDAL, Singapore (SG); Chen LIANG, Singapore (SG); Adrian-Ioan MARGIN, Cluj Napoca (RO); Hannes Martin KRUPPA, Singapore (SG)

(21) Appl. No.: 18/855,666

(22) PCT Filed: May 2, 2023
(86) PCT No.: PCT/SG2023/050297

§ 371 Date: Oct. 10, 2024

(30) Foreign Application Priority Data
Jun. 2, 2022 (SG) 10202250012K

(51) Int. Cl. G06F 21/62; G06T 5/70; H04N 7/18; H04N 23/60; H04N 23/611; H04W 4/021

(52) U.S. Cl. CPC G06F 21/6245; G06T 5/70; H04N 7/183; H04N 23/611; H04N 23/64; H04W 4/021; G06T 2207/30201

(57) ABSTRACT

According to various embodiments, there is a device comprising: an image capturing module configured to obtain a first image capturing an external environment; a memory configured to store data; a communication interface arranged in data communication with a remote data storage; and a processor communicatively couplable with the image capturing module, the memory, and the communication interface, and configured to: detect one or more regions of the first image, wherein the one or more regions include one or more objects of a predetermined type, and generate a second image corresponding to the first image, by blurring one or more regions of the second image each corresponding to the one or more regions of the first image, wherein the processor is further configured to store the first image in the memory for a predetermined time, and transmit the second image to the remote data storage via the communication interface.

### TECHNICAL FIELD

Various embodiments relate to a device and a method for processing an image.

### BACKGROUND

With the development of information and communication technology, an online mapping services which provide images of streets, for example, street view images, or images of indoor venues, for example, indoor mapping images, are widely used. Users may view the images of an area they are searching, and better understand the area.

Current methods for processing the image may be to obtain the image using a camera, for example, mounted on a vehicle, and then upload the image to a cloud to process the image. However, the image may include personal identifiable information (PII), such as faces of people, licence plates of vehicles, etc., which could potentially identify a specific individual. As such, after receiving the image from the camera, the cloud may blur a region of the personal identifiable information included in the image, so that public is unable to recognise the personal identifiable information included in the image.

However, the current methods may have several problems. As an example, in case of a data breach in the cloud, the public may have access to the non-blurred region of the personal identifiable information included in the image, as the image is stored in the cloud without blurring the region of the personal identifiable information. As another example, a current blurring algorithm may blur a region of non-personal identifiable information, by wrongly detecting the region of non-personal identifiable information as the region of personal identifiable information.

Accordingly, there exists a need for providing an improved solution for processing the image.

### SUMMARY

According to various embodiments, there is a device for processing an image, the device comprising: an image capturing module configured to obtain a first image capturing an external environment; a memory configured to store data; a communication interface arranged in data communication with a remote data storage; and a processor communicatively couplable with the image capturing module, the memory, and the communication interface, and configured to: detect one or more regions of the first image, wherein the one or more regions include one or more objects of a predetermined type, and generate a second image corresponding to the first image, by blurring one or more regions of the second image each corresponding to the one or more regions of the first image, wherein the processor is further configured to store the first image in the memory for a predetermined time, and transmit the second image to the remote data storage via the communication interface.

In some embodiments, the processor is configured to store the first image in the memory in an encrypted format.

In some embodiments, where the processor receives a request from a third party to transmit the first image to the remote data storage, the processor is configured to: check if the third party obtains a predetermined approval, and transmit the first image to the remote data storage if the third party obtains the predetermined approval.

In some embodiments, the processor is configured to: detect if the device is located within a predetermined geofence, and control the image capturing module to stop obtaining the first image if the device is detected to be located within the predetermined geofence.

In some embodiments, the processor is configured to: detect a context of the external environment, and control the image capturing module to stop obtaining the first image if the context of the external environment relates to a predetermined context.

In some embodiments, where the processor receives a notification that at least one of the one or more regions of the second image does not include an object of the predetermined type from a third party, the processor is configured to check whether the predetermined time has passed.

In some embodiments, if the predetermined time has not passed, the processor is configured to: check if the third party obtains a predetermined approval, extract the first image from the memory if the third party obtains the predetermined approval, generate another second image corresponding to the extracted first image, without blurring a region of the another second image corresponding to the at least one of the one or more regions of the second image, and transmit the another second image to the remote data storage.

In some embodiments, if the predetermined time has passed, the processor is configured to: generate information about the at least one of the one or more regions of the second image, and use the information as a training instance for training the processor, so that when another first image capturing the external environment is obtained, a region of the another first image corresponding to the at least one of the one or more regions of the second image is not blurred.

In some embodiments, the information includes at least one of geo-coordinates and 3D coordinates of the at least one of the one or more regions of the second image.

According to various embodiments, there is a method for processing an image in a device, the method comprising: obtaining a first image capturing an external environment; detecting one or more regions of the first image, wherein the one or more regions include one or more objects of a predetermined type; generating a second image corresponding to the first image, by blurring one or more regions of the second image each corresponding to the one or more regions of the first image; storing the first image in a memory of the device for a predetermined time; and transmitting the second image to a remote data storage via data communication with the remote data storage.

In some embodiments, the storing the first image in the memory comprises: storing the first image in the memory in an encrypted format.

In some embodiments, the method further comprises: where a request to transmit the first image to the remote data storage is received from a third party, checking if the third party obtains a predetermined approval; and transmitting the first image to the remote data storage if the third party obtains the predetermined approval.

In some embodiments, the method further comprises: detecting if the device is located within a predetermined geofence; and stopping obtaining the first image if the device is detected to be located within the predetermined geofence.

In some embodiments, the method further comprises: detecting a context of the external environment; and stopping obtaining the first image if the context of the external environment relates to a predetermined context.

In some embodiments, the method further comprises: where a notification that at least one of the one or more regions of the second image does not include an object of the predetermined type is received from a third party, checking whether the predetermined time has passed.

In some embodiments, the method further comprises: if the predetermined time has not passed, checking if the third party obtains a predetermined approval; extracting the first image from the memory if the third party obtains the predetermined approval; generating another second image corresponding to the extracted first image, without blurring a region of the another second image corresponding to the at least one of the one or more regions of the second image; and transmitting the another second image to the remote data storage.

In some embodiments, the method further comprises: if the predetermined time has passed, generating information about the at least one of the one or more regions of the second image; and using the information as a training instance for training a processor performing the method, so that when another first image capturing the external environment is obtained, a region of the another first image corresponding to the at least one of the one or more regions of the second image is not blurred.

In some embodiments, the information includes at least one of geo-coordinates and 3D coordinates of the at least one of the one or more regions of the second image.

According to various embodiments, a data processing apparatus configured to perform the method of any one of the above embodiments is provided.

According to various embodiments, a computer program element comprising program instructions, which, when executed by one or more processors, cause the one or more processors to perform the method of any one of the above embodiments is provided.

According to various embodiments, a computer-readable medium comprising program instructions, which, when executed by one or more processors, cause the one or more processors to perform the method of any one of the above embodiments is provided. The computer-readable medium may include a non-transitory computer-readable medium.

According to various embodiments, there is a system for processing an image. The system comprises a remote data storage configured to store data. The system further comprises a device comprising: an image capturing module configured to obtain a first image capturing an external environment; a memory configured to store data; a communication interface arranged in data communication with a remote data storage; and a processor communicatively couplable with the image capturing module, the memory, and the communication interface, and configured to: detect one or more regions of the first image, wherein the one or more regions include one or more objects of a predetermined type, and generate a second image corresponding to the first image, by blurring one or more regions of the second image each corresponding to the one or more regions of the first image, wherein the processor is further configured to store the first image in the memory for a predetermined time, and transmit the second image to the remote data storage via the communication interface.

### BRIEF DESCRIPTION OF THE DRAWINGS

The invention will be better understood with reference to the detailed description when considered in conjunction with the non-limiting examples and the accompanying drawings, in which:

FIG. 1 illustrates an infrastructure of a system for processing an image according to various embodiments.

FIGS. 2A and 2B illustrate exemplary diagrams of a device for obtaining an image according to various embodiments.

FIG. 3 illustrates a block diagram of a device for processing an image according to various embodiments.

FIGS. 4A and 4B illustrate exemplary diagrams of images according to various embodiments.

FIG. 5 illustrates a flow diagram for a method for processing an image according to various embodiments.

### DETAILED DESCRIPTION

The following detailed description refers to the accompanying drawings that show, by way of illustration, specific details and embodiments in which the disclosure may be practiced. These embodiments are described in sufficient detail to enable those skilled in the art to practice the disclosure. Other embodiments may be utilized, and structural and logical changes may be made without departing from the scope of the disclosure. The various embodiments are not necessarily mutually exclusive, as some embodiments can be combined with one or more other embodiments to form new embodiments.

Embodiments described in the context of one of a server and a method are analogously valid for the other of the server and method. Similarly, embodiments described in the context of a server are analogously valid for a method, and vice-versa.

Features that are described in the context of an embodiment may correspondingly be applicable to the same or similar features in the other embodiments. Features that are described in the context of an embodiment may correspondingly be applicable to the other embodiments, even if not explicitly described in these other embodiments. Furthermore, additions and/or combinations and/or alternatives as described for a feature in the context of an embodiment may correspondingly be applicable to the same or similar feature in the other embodiments.

In the context of various embodiments, the articles “a”, “an” and “the” as used with regard to a feature or element include a reference to one or more of the features or elements.

As used herein, the term “and/or” includes any and all combinations of one or more of the associated listed items.

Throughout the description, the term “module” may be understood as an application specific integrated circuit (ASIC), an electronic circuit, a combinational logic circuit, a field programmable gate array (FPGA), a processor which executes code, other suitable hardware components which provide the described functionality, or any combination thereof. The term of “module” may include a memory which stores code executed by the processor.

In the following, embodiments will be described in detail.

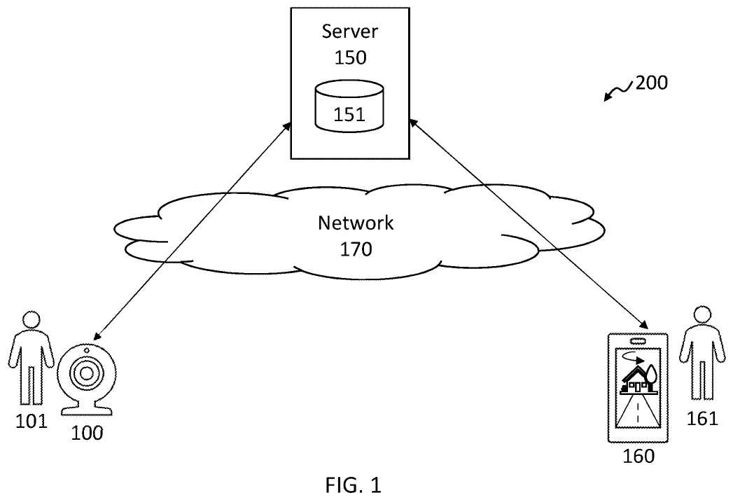

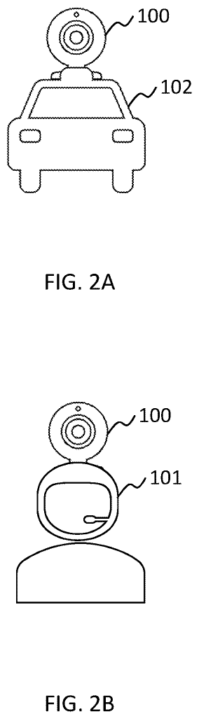

FIG. 1 illustrates an infrastructure of a system 200 for processing an image according to various embodiments. FIGS. 2A and 2B illustrate exemplary diagrams of a device 100 for obtaining the image according to various embodiments.

As shown in FIG. 1, the system 200 may include, but is not limited to, the device 100, a server 150, and a network 170. The system 200 may further include a computing device 160.

In some embodiments, online mapping services may be services which provide images of streets (for example, street view images) or indoor venues (for example, indoor mapping images). For example, a street view service may be one of the online mapping services which provides an image (for example, a panoramic street view image) from positions along the streets. A user 161 may view the image of an area they are searching via the computing device 160, and better understand the area.

In some embodiments, the network 170 may include, but is not limited to, a Local Area Network (LAN), a Wide Area Network (WAN), a Global Area Network (GAN), or any combination thereof. The network 170 may provide a wireline communication, a wireless communication, or a combination of the wireline and wireless communication between the device 100 and the server 150, and between the server 150 and the computing device 160.

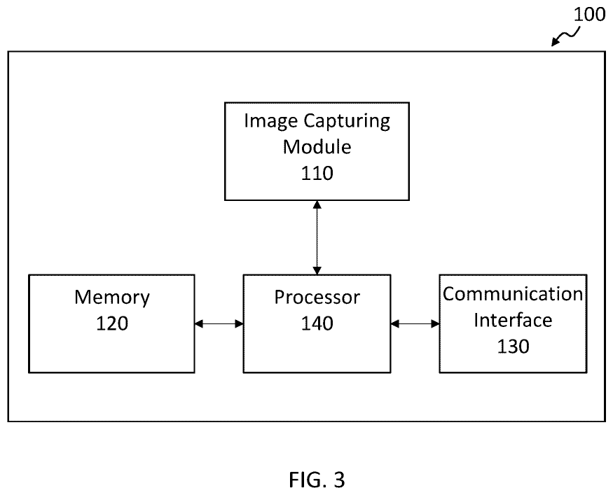

In some embodiments, the device 100 may be configured to obtain the image and process the image. In some embodiments, the device 100 may include an image capturing module 110, a memory 120, a communication interface 130, and a processor 140 (as will be described with reference to FIG. 3). In some embodiments, the device 100 may include, but is not limited to, at least one of the following: a camera device (for example, “KartaCam”), a mobile phone, a tablet computer, a laptop computer, a desktop computer, a head-mounted display, and a smart watch.

In some embodiments, the device 100 may be connectable to the server 150 via the network 170. In some embodiments, the device 100 may be arranged in data or signal communication with the server 150 via the network 170. In some embodiments, the device 100 may be a part of a distributed computing system. The computing of the device 100 may be referred to as an “EDGE computing”. The EDGE computing may be a deployment of computing and storage resources at a location where data, for example, the image, is produced. In some embodiments, the device 100 may include a neural network EDGE artificial intelligence (AI) chip. In some embodiments, the neural network EDGE artificial intelligence (AI) chip may include at least the memory 120 and the processor 140.

In some embodiments, the device 100 may obtain the image. In some embodiments, a user 101 may carry the device 100 to capture the image of surroundings. As shown in FIG. 2A, for example, the device 100 may be mounted on a vehicle 102, for example, a roof or a windshield of a car or a pole on a back of a motorcycle, that the user 101 is driving, to capture the image of the surroundings. As shown in FIG. 2B, as another example, the device 100 may be mounted on a helmet of the user 101, to capture the image of the surroundings. In some embodiments, the user 101 may include a specialist personnel who may systematically follow predetermined routes by driving through streets and along roads, to obtain the image according to the predetermined routes. In some other embodiments, the user 101 may include a service provider who may provide an on-demand service according to the predetermined routes based on a service user's request for the on-demand service.

In some embodiments, the device 100 may generate information about the location of the device 100. In some embodiments, the device 100 may record the location of the device 100 with every exposure, so that the image can be matched to the corresponding GPS position. In some other embodiments, the device 100 may generate information about the location and the orientation of the device 100. In some embodiments, the device 100 may record the location and the orientation of the device 100 with every exposure.

In some embodiments, the device 100 may process the obtained image (hereinafter, also referred to as a “first image”). In some embodiments, the device 100 may detect one or more regions of the first image. The one or more regions may include one or more objects of a predetermined type. In some embodiments, the one or more objects of the predetermined type may include an object relating to personal identifiable information, for example, faces of people, licence plates of vehicles, etc. The device 100 may then generate another image (hereinafter, also referred to as a “second image”) corresponding to the first image, by blurring one or more regions of the second image each corresponding to the one or more regions of the first image.

In some embodiments, the device 100 may store the first image in the memory 120 for a predetermined time. In this manner, the first image without blurring the region of the personal identifiable information may be stored in the memory 120 for the predetermined time. In some embodiments, if the predetermined time has passed, the device 100 may delete the first image from the memory 120. In some other embodiments, if the predetermined time has passed, the device 100 may disable the first image stored in the memory 120.

In some embodiments, the server 150, for example, implemented by a server computer, may include a remote data storage 151. The remote data storage 151 may be implemented locally in the server 150. In some embodiments, the server 150 may be referred to as a “cloud server”. In some embodiments, the remote data storage 151 may be referred to as a “cloud data storage”.

Although not shown, in some other embodiments, the remote data storage 151 may be a part of a database system which may be external to the server 150. In some embodiments, the server 150 may communicate with the remote data storage 151.

In some embodiments, the server 150 may communicate with the device 100 via the network 170. In some embodiments, the device 100 may transmit the second image to the server 150 via the network 170. In some embodiments, the device 100 may transmit information about a location that the first image (corresponding to the second image) was captured, to the server 150 via the network 170. In some other embodiments, the device 100 may transmit information about the location and an orientation that the first image (corresponding to the second image) was captured, to the server 150 via the network 170. In this manner, the second image with blurring the region of the personal identifiable information may be transmitted to the server 150 and stored in the remote data storage 151, so that public is able to view the second image for an area of interest, but unable to view the personal identifiable information.

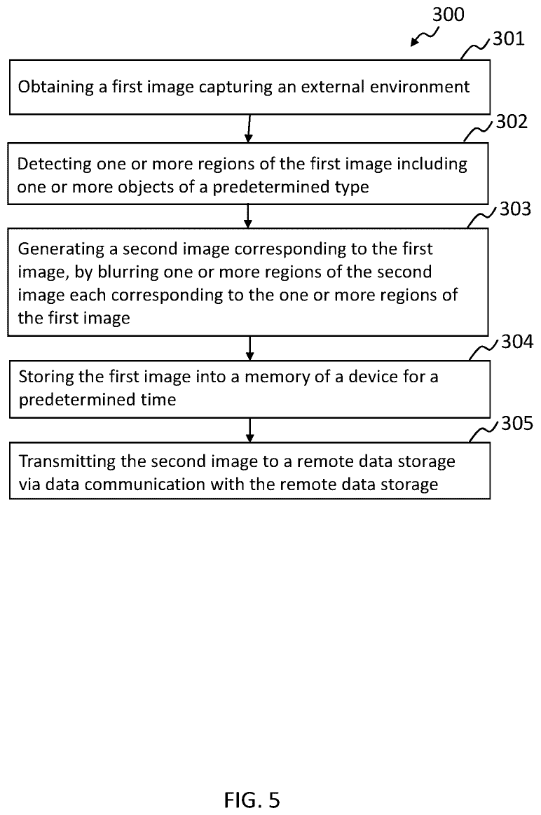

Although not shown, the system 200 may comprise a plurality of devices 100, and the method 300 (as will be described with reference to FIG. 5) may be performed in the each of the plurality of devices 100 as the EDGE computing. The each of the plurality of devices 100 may obtain the image of surroundings of the each of the plurality of devices 100, and process the obtained image respectively.

In some embodiments, the computing device 160 may be connectable to the server 150 via the network 170. In some embodiments, the computing device 160 may be arranged in data or signal communication with the server 150 via the network 170. In some embodiments, the computing device 160 may include, but is not limited to, at least one of the following: a mobile phone, a tablet computer, a laptop computer, a desktop computer, a head-mounted display and a smart watch. In some embodiments, the computing device 160 may belong to the user 161. For example, the user 161 may include a map service user who may search an area using the computing device 160.

In some embodiments, the computing device 160 may include a location sensor. In some embodiments, the location sensor may communicate with at least one of a global positioning satellite (GPS) server, a network server, and a Wi-Fi server, to detect a location of the computing device 160. In some embodiments, the computing device 160 may generate information about a location of the computing device 160.

In some embodiments, the computing device 160 may have installed thereon a software application (also referred to as a “user app”) which may allow the user 161 to search an area and view an image (for example, a street level panoramic image) of the area. In some embodiments, the user 161 may search the area of interest using a user interface provided by the software application. The software application may transmit the area of interest with the information about the location of the computing device 160 to the server 150. The server 150 may extract the second image for the area of interest from the remote data storage 151, and transmit the second image for the area of interest to the computing device 160, so that the user 161 can view the second image for the area of interest using the computing device 160.

FIG. 3 illustrates a block diagram of a device 100 for processing an image according to various embodiments.

As shown in FIG. 3, the device 100 may include an image capturing module 110, a memory 120, a communication interface 130, and a processor 140.

In some embodiments, the image capturing module 110 may obtain an image (hereinafter, also referred to as a “first image”) capturing an external environment. The first image may include an image capturing the external environment. The first image may be at least one of a static image (also referred to as a “still image”) and sequences of images (also referred to as a “moving image” or a “video”). In some embodiments, the first image may be a panoramic image. In some other embodiments, the first image may be a non-panoramic image. In some embodiments, the image capturing module 110 may be in a form of a camera, for example, an RGB camera. In some embodiments, the image capturing module 110 may generate a raw data image. Thereafter, the image capturing module 110 may process, for example interpret, the raw data image to obtain the first image.

In some embodiments, the image capturing module 110 may be physically mounted on the device 100. Although not shown, in some other embodiments, the image capturing module 110 may be physically mounted on other devices, for example, an image capturing device (not shown) which is communicatively connectable to the device 100.

In some embodiments, the image capturing module 110 may have a certain degree field of view (for example, a 150-degree field of view). In some embodiments, the device 100 may include a plurality of image capturing modules 110, for example, four (4) image capturing modules 110. The plurality of image capturing modules 110 may be grouped and synchronised to create a 360-degree field of view. In some embodiments, each of the plurality of image capturing modules 110 may have the same degree field of view. In some other embodiments, each of the plurality of image capturing modules 110 may have a different degree field of view.

Although not shown, in some embodiments, the device 100 may further include a location sensor. In some embodiments, the location sensor may communicate with at least one of a global positioning satellite (GPS) server, a network server, and a Wi-Fi server, to detect a location of the device 100.

Although not shown, in some embodiments, the device 100 may further include an orientation sensor. In some embodiments, the orientation sensor may detect an orientation (tilt) of the device 100. The orientation sensor may include, but not be limited to, an accelerometer, a gyroscope, and a magnetometer. For example, the accelerometer may detect the orientation of the device 100 by measuring an acceleration due to the gravity.

In some embodiments, the device 100 may generate information about the location of the device 100. In some embodiments, the device 100 may record the location of the device 100 with every exposure, so that the image can be matched to the corresponding GPS position. In some other embodiments, the device 100 may generate information about the location and the orientation of the device 100. In some embodiments, the device 100 may record the location and the orientation of the device 100 with every exposure.

In some embodiments, the memory 120 (also referred to as a “database”) may store input data and/or output data temporarily or permanently. In some embodiments, the memory 120 may store program code which allows the device 100 to perform a method 300 (as will be described with reference to FIG. 5). In some embodiments, the program code may be embedded in a Software Development Kit (SDK). The memory 120 may include an internal memory of the device 100 and/or an external memory. The external memory may include, but is not limited to, an external storage medium, for example, a memory card and a flash drive.

In some embodiments, the communication interface 130 may allow the device 100 to communicate with a server 150 via the network 170, as shown in FIG. 1. In some embodiments, the communication interface 130 may transmit signals to the server 150, and/or receive signals from the server 150 via the network 170. The server 150 may include a remote data storage 151. The communication interface 130 may allow the device 100 to communicate with the remote data storage 151 via the network 170.

The processor 140 may include, but is not limited to, a microprocessor, an analogue circuit, a digital circuit, a mixed-signal circuit, a logic circuit, an integrated circuit, a Central Processing Unit (CPU), a Graphics Processing Unit (GPU), a Digital Signal Processor (DSP), a Field Programmable Gate Array (FPGA), an Application Specific Integrated Circuit (ASIC), or any combination thereof. Any other kind of implementation of the respective functions, which will be described below in further detail, may also be understood as the processor 140.

In some embodiments, the processor 140 may be communicatively couplable with the image capturing module 110. In some embodiments, the processor 140 may be arranged in data or signal communication with the image capturing module 110 to receive the first image from the image capturing module 110.

In some embodiments, the processor 140 may be communicatively couplable with the memory 120. In some embodiments, the processor 140 may be arranged in data or signal communication with the memory 120 to store data, for example, the first image, in the memory 120.

In some embodiments, the processor 140 may be communicatively couplable with the communication interface 130. In some embodiments, the processor 140 may be arranged in data or signal communication with the communication interface 130 to transmit data, for example, the second image generated by the processor 140, to the remote data storage 151 of the server 150 via the network 170.

In some embodiments, the processor 140 may receive the first image from the image capturing module 110. The first image may include a single image or a plurality of images. In some embodiments, the processor 140 may receive the first image from the image capturing module 110 at a predetermined time interval. For example, the processor 140 may receive the plurality of images obtained by the image capturing module 110 during the predetermined time, at the predetermined time interval. In some other embodiments, the processor 140 may receive the first image from the image capturing module 110 on a real time basis. For example, the processor 140 may receive the first image right after the image capturing module 110 obtains the first image.

In some embodiments, the processor 140 may detect one or more regions of the first image. The one or more regions may include one or more objects of a predetermined type. In some embodiments, the processor 140 may scan for the one or more regions of the first image that include one or more objects of the predetermined type. In some embodiments, the processor 140 may detect the one or more regions of the first image based on at least a content of the first image.

In some embodiments, the one or more objects of the predetermined type may include an object relating to personal identifiable information, for example, faces of people, licence plates of vehicles, etc. For example, the processor 140 may detect the region that includes the faces. As another example, the processor 140 may detect the region that includes the licence plates. In some embodiments, the processor 140 may update information about the predetermined type upon receipt of a request or at a predetermined time interval.

In some embodiments, the processor 140 may generate a second image corresponding to the first image. In some embodiments, the processor 140 may blur one or more regions of the second image each corresponding to the one or more regions of the first image which include the one or more objects of the predetermined type, to generate the second image. In this manner, in the second image, the one or more objects of the predetermined type, for example, the object relating to the personal identifiable information, may be blurred.

Therefore, according to various embodiments, the blurring operation may not be performed in the server 150. According to various embodiments, the blurring operation may be performed in the device 100 as an EDGE computing.

In some embodiments, the processor 140 may store the first image in the memory 120 for a predetermined time. In this manner, the first image without blurring the region of the personal identifiable information may be stored in the memory 120 for the predetermined time. In some embodiments, if the predetermined time has passed, the device 100 may delete the first image from the memory 120. In some other embodiments, if the predetermined time has passed, the device 100 may disable the first image stored in the memory 120.

In some embodiments, the predetermined time may be set by the user 101. In some other embodiments, the predetermined time may be set by the device 100 itself or the server 150. In some embodiments, the predetermined time may be adjusted based on a predetermined condition, for example, a data privacy law of a country that the first image was captured. For example, the predetermined time may be 14 days.

In some embodiments, the processor 140 may store the first image in the memory 120 in an encrypted format. In some embodiments, the processor 140 may encrypt the first image, and store the encrypted first image in the memory 120. In this manner, the first image without blurring the region of the personal identifiable information may be stored in the memory 120 in the encrypted format, and thus a third party is unable to open the first image without decryption.

In some embodiments, the processor 140 may use a public/private key encryption to encrypt the first image (i.e. a non-blurred image) together with a password (i.e. with everything visible). The private key for decryption may only be available to a limited set of users/parties having a right to request the encrypted image to be unblurred and/or decrypted. Therefore, the other parties (for example, driver collecting the first image, regular operations teams, or any third party) may not be able to access the first image. In some embodiments, the processor 140 may have a mechanism/algorithm so that the public/private key pair is unique per the device 100 (for example, a camera device) and/or per the day of collection of the first image. In this manner, the limited set of users/parties who have the access to the decryption may not access the other images, except certain images allowed to them.

In some embodiments, the processor 140 may transmit the second image to the remote data storage 151 via the communication interface 130. In some embodiments, the processor 140 may transmit the information about the location that the first image (corresponding to the second image) was captured, to the remote data storage 151 via the communication interface 130. In some other embodiments, the processor 140 may transmit the information about the location and the orientation that the first image (corresponding to the second image) was captured, to the remote data storage 151 via the communication interface 130. In this manner, the second image with blurring the region of the personal identifiable information may be transmitted to the remote data storage 151 and stored in the remote data storage 151, so that public can view the second image for an area of interest, with blurring the region of the personal identifiable information. The non-blurred region of the personal identifiable information may not be transmitted to the remote data storage 151, and not be stored in the remote data storage 151.

Therefore, according to various embodiments, even if the device 100 is stolen, the first image without blurring the region of the personal identifiable information may not be accessible, as the first image may be stored in the memory 120 of the device 100 only for the predetermined time in the encrypted format. In addition, even if there is a data breach in the server 150, the first image without blurring the region of the personal identifiable information may not be accessible in the server 150.

In some embodiments, the processor 140 may receive a request from a third party to transmit the first image to the remote data storage 151. In some embodiments, the processor 140 may receive the request from the third party via the server 150. The processor 140 may check if the third party obtains a predetermined approval. For example, the third party may include a privacy officer having the predetermined approval. If the third party obtains the predetermined approval, the processor 140 may transmit the first image to the remote data storage 151 of the server 150 and/or the third party.

In some embodiments, where the processor 140 receives the request from the third party to transmit the first image to the remote data storage 151, the processor 140 may check if the predetermined time has passed. If the predetermined time has not passed and the third party obtains the predetermined approval, the processor 140 may transmit the first image stored in the memory 120 to the remote data storage 151 and/or the third party. If however the predetermined time has passed, the processor 140 may not transmit the first image to the remote data storage 151 and/or the third party, as the first image has already been deleted from the memory 120. In some embodiments, if the predetermined time has passed, the processor 140 may inform the server 150 and/or the third party that the first image is not available.

In some embodiments, the processor 140 may detect if the device 100 is located within a predetermined geofence. In some embodiments, the processor 140 may obtain location information of the device 100 from a location sensor (not shown), and detect if the location of the device 100 is within the predetermined geofence. If the device 100 is detected to be located within the predetermined geofence, the processor 140 may control the image capturing module 110 to stop obtaining the first image. For example, if the processor 140 detects that the device 100 is located within the predetermined geofence, such as a military zone or a religious centre, which may require further privacy protection, the processor 140 may control the image capturing module 110 to stop obtaining the first image. In some embodiments, if the processor 140 then detects that the device 100 is located outside the predetermined geofence, the processor 140 may control the image capturing module 110 to obtain the first image.

In some embodiments, the processor 140 may detect a context of the external environment. In some embodiments, the processor 140 may receive the first image of the external environment obtained by the image capturing module 110, and detect the context of the external environment. If the context of the external environment relates to a predetermined context, the processor 140 may control the image capturing module 110 to stop obtaining the first image. For example, if the processor 140 detects that the context of the external environment relates to the predetermined context, such as a restroom or a private home, which may include a sensitive scene, the processor 140 may control the image capturing module 110 to stop obtaining the first image.

In some embodiments, the processor 140 may receive a notification that at least one of the one or more regions of the second image does not include an object of the predetermined type from a third party. In some embodiments, the processor 140 may receive the notification from the third party via the server 150. For example, a certain region of the second image merely includes a street name sign, but it was detected as a licence plate and thus wrongly blurred. The processor 140 may receive the notification informing that the certain region of the second image is wrongly blurred. Where the processor 140 receives the notification that the at least one of the one or more regions of the second image does not include the object of the predetermined type, the processor 140 may check whether the predetermined time has passed.

In some embodiments, if the predetermined time has not passed, the processor 140 may check if the third party obtains a predetermined approval. If the third party obtains the predetermined approval, the processor 140 may extract the first image from the memory 120. As the predetermined time has not passed, the first image may still be stored in the memory 120. The processor 140 may generate another second image corresponding to the extracted first image. In some embodiments, the processor 140 may blur one or more regions of the another second image each corresponding to one or more regions of the extracted first image which include the one or more objects of the predetermined type, to generate the another second image. However, the processor 140 may not blur a region of the another second image corresponding to the at least one of the one or more regions of the second image (hereinafter, also referred to as a “wrongly blurred region”). In other words, the processor 140 may not blur the wrongly blurred region to generate the another second image. Thereafter, the processor 140 may transmit the another second image to the remote data storage 151 and/or the third party.

In some embodiments, if the predetermined time has passed, the processor 140 may generate information about the at least one of the one or more regions of the second image (hereinafter, also referred to as a “wrongly blurred region”), and use the information as a training instance for training the processor 140.

In some embodiments, the information may include at least one of geo-coordinates and 3D coordinates of the wrongly blurred region. In some embodiments, the geo-coordinates and/or the 3D coordinates may have expiration dates to consider real-world changes. As an example, a period till the expiration date is 30 days. For example, the processor 140 may control the image capturing module 110 to obtain another first image capturing the external environment after the expiration dates.

In some embodiments, the processor 140 may use a machine learning model. In some embodiments, the machine learning model may return a segmentation mask of an image with a region including features (objects) of the personal identifiable information (for example, faces of people, licence plates of vehicles, etc.). After the machine learning model recognises the features from the image, a blurring technology may blur the features.

In some embodiments, the processor 140 may use the information about the wrongly blurred region as input data relating to a plurality of variables. In some embodiments, the processor 140 may input the input data to the machine learning model. In some embodiments, the machine learning model may be trained to output an image without blurring the wrongly blurred region based on values of the plurality of variables. In this manner, when another first image capturing the same external environment is obtained, the wrongly blurred region may not be blurred to generate another second image corresponding to the another first image. Accordingly, a blurring algorithm may be improved by training the machine learning model using a false-positive detection. For example, after the expiration dates (for example, 30 days), the another first image capturing the same external environment may be obtained, and the wrongly blurred region may not be blurred in the another second image corresponding to the another first image.

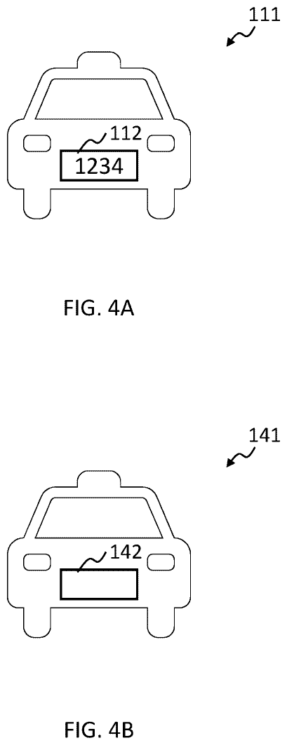

FIGS. 4A and 4B illustrate exemplary diagrams of images according to various embodiments.

FIG. 4A shows a first image 111. The image capturing module 110 of the device 100 may obtain the first image 111 (as described with reference to FIG. 3). The first image 111 may include a region 112 including an object of a predetermined type. For example, the first image 111 may include the region 112 including a licence plate. The first image 111 showing the licence plate number may be stored in the memory 120 for a predetermined time, for example, in an encrypted format.

FIG. 4B shows a second image 141. The processor 140 may process the first image 111 to generate the second image 141 (as described with reference to FIG. 3). The processor 140 may blur a region 142 of the second image 141 corresponding to the region 112 of the first image 111 including the licence plate. Therefore, the second image 141 may not show the licence plate number. The second image 141 may be transmitted to the remote data storage 151.

FIG. 5 illustrates a flow diagram for a method 300 for processing an image according to various embodiments. According to various embodiments, the method 300 for processing the image may be provided.

In some embodiments, the method 300 may include a step 301 of obtaining a first image capturing an external environment.

In some embodiments, the method 300 may include a step 302 of detecting one or more regions of the first image. The one or more regions of the first image may include one or more objects of a predetermined type.

In some embodiments, the method 300 may include a step 303 of generating a second image corresponding to the first image, by blurring one or more regions of the second image each corresponding to the one or more regions of the first image.

In some embodiments, the method 300 may include a step 304 of storing the first image into a memory of a device for a predetermined time. In some embodiments, the method may store the first image into the memory of the device for the predetermined time, in an encrypted format.

In some embodiments, the method 300 may include a step 305 of transmitting the second image to a remote data storage via data communication with the remote data storage.

While the disclosure has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

1. A device for processing an image, the device comprising:
an image capturing module configured to obtain a first image capturing an external environment;
a memory configured to store data;
a communication interface arranged in data communication with a remote data storage; and
a processor communicatively couplable with the image capturing module, the memory, and the communication interface, and configured to:
detect one or more regions of the first image, wherein the one or more regions include one or more objects of a predetermined type, and
generate a second image corresponding to the first image, by blurring one or more regions of the second image each corresponding to the one or more regions of the first image. wherein the processor is further configured to store the first image in the memory for a predetermined time, and transmit the second image to the remote data storage via the communication interface.

2. The device according to claim 1, wherein the processor is configured to store the first image in the memory in an encrypted format.

3. The device according to claim 1, wherein where the processor receives a request from a third party to transmit the first image to the remote data storage, the processor is configured to:
check if the third party obtains a predetermined approval, and
transmit the first image to the remote data storage if the third party obtains the predetermined approval.

4. The device according to claim 1, wherein the processor is configured to:
detect if the device is located within a predetermined geofence, and
control the image capturing module to stop obtaining the first image if the device is detected to be located within the predetermined geofence.

5. The device according to claim 1, wherein the processor is configured to:
detect a context of the external environment, and
control the image capturing module to stop obtaining the first image if the context of the external environment relates to a predetermined context.

6. The device according to claim 1, wherein where the processor receives a notification that at least one of the one or more regions of the second image does not include an object of the predetermined type from a third party, the processor is configured to check whether the predetermined time has passed.

7. The device according to claim 6, wherein if the predetermined time has not passed, the processor is configured to:
check if the third party obtains a predetermined approval,
extract the first image from the memory if the third party obtains the predetermined approval,
generate another second image corresponding to the extracted first image, without blurring a region of the another second image corresponding to the at least one of the one or more regions of the second image, and
transmit the another second image to the remote data storage.

8. The device according to claim 6, wherein if the predetermined time has passed, the processor is configured to:
generate information about the at least one of the one or more regions of the second image, and
use the information as a training instance for training the processor, so that when another first image capturing the external environment is obtained, a region of the another first image corresponding to the at least one of the one or more regions of the second image is not blurred.

9. The device according to claim 8, wherein the information includes at least one of geocoordinates and 3D coordinates of the at least one of the one or more regions of the second image.

10. A method for processing an image in a device, the method comprising:
obtaining a first image capturing an external environment;
detecting one or more regions of the first image, wherein the one or more regions include one or more objects of a predetermined type;
generating a second image corresponding to the first image, by blurring one or more regions of the second image each corresponding to the one or more regions of the first image;
storing the first image in a memory of the device for a predetermined time; and
transmitting the second image to a remote data storage via data communication with the remote data storage.

11. The method according to claim 10, wherein the storing the first image in the memory comprises: storing the first image in the memory in an encrypted format.

12. The method according to claim 10 further comprising: where a request to transmit the first image to the remote data storage is received from a third party, checking if the third party obtains a predetermined approval; and
transmitting the first image to the remote data storage if the third party obtains the predetermined approval.

13. The method according to claim 10 further comprising:
detecting if the device is located within a predetermined geofence; and
stopping obtaining the first image if the device is detected to be located within the predetermined geofence.

14. The method according to claim 10 further comprising:
detecting a context of the external environment; and
stopping obtaining the first image if the context of the external environment relates to a predetermined context.

15. The method according to claim 10 further comprising: where a notification that at least one of the one or more regions of the second image does not include an object of the predetermined type is received from a third party, checking whether the predetermined time has passed.

16. The method according to claim 15 further comprising:
if the predetermined time has not passed,
checking if the third party obtains a predetermined approval;
extracting the first image from the memory if the third party obtains the predetermined approval;
generating another second image corresponding to the extracted first image, without blurring a region of the another second image corresponding to the at least one of the one or more regions of the second image; and
transmitting the another second image to the remote data storage.

17. The method according to claim 15 further comprising: if the predetermined time has passed,
generating information about the at least one of the one or more regions of the second image; and
using the information as a training instance for training a processor performing the method, so that when another first image capturing the external environment is obtained, a region of the another first image corresponding to the at least one of the one or more regions of the second image is not blurred.

18. The method according to claim 17, wherein the information includes at least one of geocoordinates and 3D coordinates of the at least one of the one or more regions of the second image.

19. A data processing apparatus configured to perform the method of claim 10.

20. A computer-readable medium comprising program instructions, which, when executed by one or more processors, cause the one or more processors to perform the method of claim 10
